(19) United States
(12) Patent Application Publication
(10) Pub. No.: US 2013/0099687 A1
(43) Pub. Date: Apr. 25, 2013

(54) AC LED DRIVE CIRCUIT

(71) Applicant: Marcus Zhang, Yuyao (CN)

(72) Inventor: Marcus Zhang, Yuyao (CN)

(21) Appl. No.: 13/379,033

(22) PCT Filed: Oct. 26, 2011
(86) PCT No.: PCT/CN2011/081330

§ 371 Date: Dec. 19, 2011

(30) Foreign Application Priority Data
Oct. 24, 2011 (CN) 201110326626.8

(51) Int. Cl. H05B 37/00

(52) U.S. Cl. 315/192

(57) ABSTRACT

The present patent application discloses an AC LED drive circuit, comprising four rectifier diodes, a current constant diode and k groups of LED units in parallel; four rectifier diodes constitute a full bridge rectifier circuit; inputs of the bridge rectifiers are AC1 and AC2; the outputs of the bridge rectifiers are a circuit including n series connections by k parallel connections and then serially connected with a current constant diode. The present patent application employs four rectifier diodes and a current constant diode to drive the AC LED drive circuit of the LED so as to make the availability of LED up to 100%, thus improving the light efficiency and reducing the cost.

### FIELD OF THE PATENT APPLICATION

The present patent application relates to LED drive technical field, and more particularly, to an AC LED drive circuit.

### BACKGROUND

The current AC LED drive circuit employs the following two methods:

The first LED drive circuit, as shown in FIG. 1, comprises two groups of LED units, each LED unit is composed by a plurality of LEDs in serial connection and the two groups of LED units are connected in parallel reversely, and two common terminals thereof are connected with two input terminals of the AC power supply, respectively. Taking the wave shape of the AC power supply being sine wave for example, the wave shape of the AC power supply is shown in FIG. 2, wherein t1-t3 is one period of the wave shape. When the LED drive circuit as shown in FIG. 1 is employed, during t1-t2, the electric current flows from the terminal AC1 of AC power supply, flowing through LED 13, . . . , LED14 to the terminal AC2 of AC power supply, at that time LED13, . . . , LED14 are lighted on and LED11, . . . , LED12 are off; during t2-t3, the electric current flows from the terminal AC2 of AC power supply, flowing through LED 12, . . . , LED11 to the terminal AC1 of AC power supply, at that time LED12, . . . , LED11 are lighted on and LED13, . . . , LED14 are off.

The second LED drive circuit is shown in FIG. 3. Taking the wave shape of the AC power supply being sine wave for example, the wave shape of the AC power supply are shown in FIG. 2, wherein t1-t3 is one period of the wave shape. When the LED drive circuit as shown in FIG. 3 is employed, during t1-t2, the electric current flows from the terminal AC1 of AC power supply, flowing through LED1, LED2, LED3, LED4, . . . , LED5, LED6, LED7 to the terminal AC2 of AC power supply, at that time LED1, LED2, LED3, LED4, . . . , LED5, LED6, LED7 are lighted on and LED8, LED9, . . . , LED10, LED11 are off; during t2-t3, the electric current flows from the terminal AC2 of AC power supply, flowing through LED8, LED6, LED9, . . . , LED4, LED10, LED2, LED11 into the terminal AC1 of AC power supply, at that time LED8, LED6, LED9, . . . , LED4, LED10, LED2, LED11 are lighted on and LED5, LED7, . . . , LED1, LED3 are off.

However, when carrying out the present patent application, the inventor finds that the AC LED drive circuit in the prior art has the following defects: the availability of LED is half when the first LED drive circuit is employed; the availability of LED is about ⅔ when the second LED drive circuit is employed, thereby the availability of LED in the related AC LED drive circuit is relatively low.

### SUMMARY

The object of the present problem is to provide an AC LED drive circuit to overcome the defect of the availability of LED in the related AC LED drive circuit is relatively low.

In order to achieve the above object, the present patent application provides An AC LED drive circuit, comprising four rectifier diodes and k groups of LED units in parallel connection, wherein k is a natural number; a full bridge rectifier circuit composed by four rectifier diodes has two input terminals being connected with two terminals AC1, AC2 of the AC input respectively, the positive electrode output terminal being connected with the positive common terminal of the k groups of LED units in parallel connection; the negative electrode output terminal being connected with the negative common terminal of the k groups of LED units in parallel connection; the LED unit is composed by n LEDs in serial connection, wherein n is a natural number.

Preferably, the circuit further comprises a current constant diode which is serially connected with k groups of LED units in parallel connection.

Preferably, in k groups of LED units in parallel connection, each LED unit is in parallel connection with a voltage stabilizing diode unit that is composed by m voltage stabilizing diodes in serial connection, wherein m is a natural number; the negative electrode of the first voltage stabilizing diode in the voltage stabilizing diode unit is connected with the positive electrode of the first LED in the LED units, and the positive electrode of mₜₕ voltage stabilizing diode is connected with the negative electrode of the nₜₕ LED.

Preferably, the positive electrode of voltage stabilizing diode in the voltage stabilizing diode unit is connected with the respective negative electrode of LED corresponding in the LED unit, and the negative electrode of voltage stabilizing diode is connected with the respective positive electrode of LED.

In comparison with the prior art, the present patent application has the following advantages:

The present patent application employs the method of four rectifier diodes driving AC LED drive circuit of the LED so as to make the availability of LED up to 100%, thus improving the light efficiency and reducing the cost.

Additionally, the rectifier diode and the current constant diode are encapsulated within the LED by connecting a current constant diode to the rectifier bridge output, such that commercially available AC power can directly drive LEDs, and thus the defect of AC LED output current being changed with the input of voltage is eliminated, while broadening the range of voltage input and enhancing the applicability.

Furthermore, in this embodiment, each of LED units is in parallel connection with voltage stabilizing diode unit, and thereby even though the parts of LED circuit are in failure, remaining LEDs may normally work without any influence.

### BRIEF DESCRIPTIONS OF THE DRAWINGS

FIG. 1 is a circuit principle drawing of an AC LED drive circuit of the prior art;

FIG. 2 is a wave-shaped drawing of an AC power supply of the prior art;

FIG. 3 is a circuit principle drawing of another AC LED drive circuit of the prior art;

FIG. 4 is a circuit principle drawing of an AC LED drive circuit of first embodiment of the present patent application;

FIG. 5 is a circuit principle drawing of an AC LED drive circuit of second embodiment of the present patent application;

FIG. 6 is a circuit principle drawing of an AC LED drive circuit of third embodiment of the present patent application; and

FIG. 7 is a circuit principle drawing of an AC LED drive circuit of fourth embodiment of the present patent application;

### DETAILED DESCRIPTION

The details of the present patent application are set forth in the accompanying drawings and embodiments below. It should be understood that the following embodiments are merely for illustrative purpose rather than limitation of the scope of present patent application.

### First embodiment

In the embodiment of the present patent application, a circuit principle drawing of the AC LED drive circuit will be shown in FIG. 4, and the circuit comprises four rectifier diodes and k groups of k groups of LED units in parallel connection, wherein k is a natural number.

The four rectifier diodes includes a first rectifier diode 41, a second rectifier diode 42, a third rectifier diode 43 and a fourth rectifier diode 44, and the four rectifier diodes constitute the full bridge rectifier, two input terminals of which are respectively connected with two terminals AC1 and AC2 of AC input.

The LED unit includes n LED(s) in serial connection, wherein n is a natural number. The k groups of k groups of LED units in parallel connection comprise the first group of LED unit(s), . . . , the kth group of LED unit (s), wherein the fist group of LED unit(s) comprises LED 1_1, . . . , LED 1_N, . . . , and the kth group of LED(s) includes LED k_1, . . . , LED k_n.

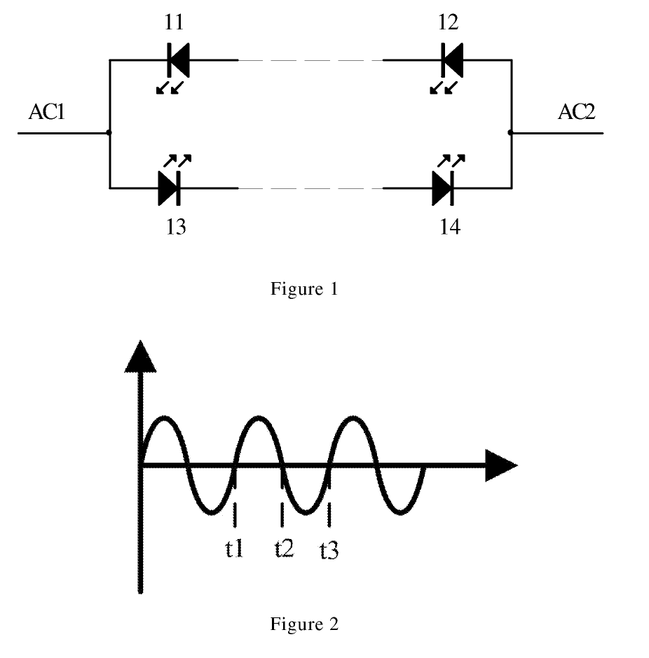

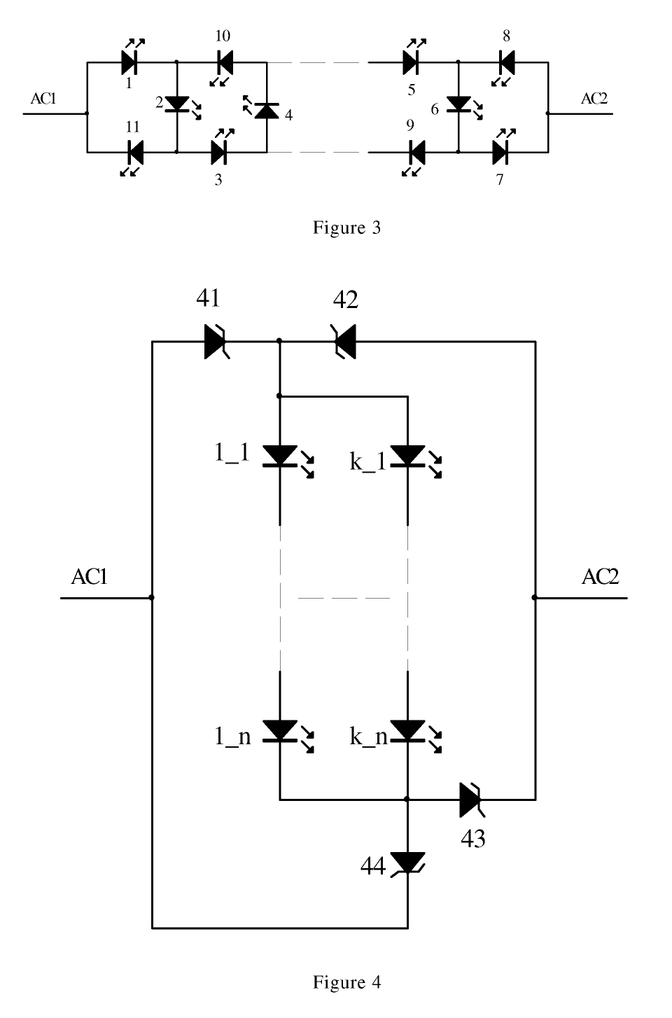

Taking the wave shape of the AC power supply being sine wave for example, the wave shape of the AC power supply is shown in FIG. 2, wherein t1-t3 is one period of the wave shape. When the LED drive circuit as shown in FIG. 4 is employed, during t1-t2, the electric current flows from the terminal AC1 of AC power supply, flowing through the first rectifier diode 41, the k groups of k groups of LED units in parallel connection and the third rectifier diode 43 to the terminal AC2 of AC power supply, at that time all LEDs are lighted on; during t2-t3, the electrical current flows from the terminal AC2 of AC power supply, flowing through the second rectifier diode 42, the k groups of k groups of LED units in parallel connection and the fourth rectifier diode 44 to the terminal AC1 of AC power supply, at that time all LEDs are lighted on on. The availability of LED is 100% when the LED drive circuit in this embodiment is employed.

This embodiment employs a rectifier bridge constituted by four rectifier diodes to drive the AC LED drive circuit of LEDs so as to make the availability of LED up to 100%, thus improving the light efficiency and reducing the cost.

### Second Embodiment

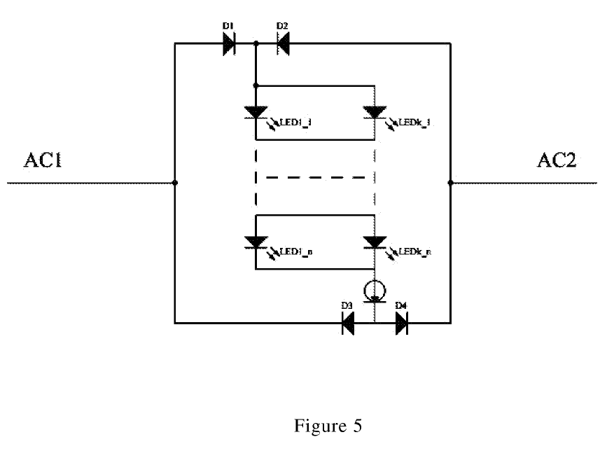

In the embodiment of the present patent application, a circuit principle drawing of the AC LED drive circuit will be shown in FIG. 5, and the circuit includes four rectifier diodes, a current constant diode and k groups of k groups of LED units in parallel connection, wherein k is a natural number.

The four rectifier diodes includes a first rectifier diode D1, a second rectifier diode D2, a third rectifier diode D3 and a fourth rectifier diode D4, and the four rectifier diodes constitute the full bridge rectifier, two input terminals of which are connected with two terminals AC1, AC2 of AC input, respectively. The output terminal of positive electrode is connected with the positive electrode common terminal of the k groups of LED units in parallel connection, and the output terminal of negative electrode is connected with the negative electrode of the current constant diode.

The current constant diode is serially connected with the k groups of LED units in parallel connection and the positive electrode thereof connects with the negative electrode common terminal of the k groups of LED units in parallel connection.

The LED unit includes n LED(s) in serial connection, wherein n is a natural number. The k groups of LED units in parallel connection include the first group of LED unit(s), . . . , the kth group of LED(s), wherein the fist group of LED unit(s) includes LED 1_1, . . . , LED 1_N, . . . , and the kth group of LED(s) includes LED k_1, . . . , LED k_n.

Taking the wave shape of the AC power supply being sine wave for example, the wave shape of the AC power supply is shown in FIG. 2, wherein t1-t3 is one period of the wave shape. When the LED drive circuit as shown in FIG. 5 is employed, during t1-t2, the electric current flows from the terminal AC1 of AC power supply, flowing through the first rectifier diode D1, the k groups of LED units in parallel connection, the current constant diode and the fourth rectifier diode D4 to the terminal AC2 of AC power supply, at that time all LEDs are lighted on; during t2-t3, the electrical current flows from the terminal AC2 of AC power supply, flowing through the second rectifier diode D2, the k groups of LED units in parallel connection, the current constant diode and the third rectifier diode D3 to the terminal AC1 of AC power supply, at that time all LEDs are lighted on. The availability of LED is 100% when the LED drive circuit in this embodiment is employed.

In this embodiment, AC LED includes a plurality of low-voltage LED wafer connected by golden wire or is formed by in a grain of LED in which a high-voltage LED wafer, a rectifier diode wafer and a current constant diode wafer are encapsulated, or alternatively AC LED is formed by separate elements without encapsulation. When the AC LED drive circuit in this embodiment is employed, it is optional to encapsulate various grains of LED according to various power supply voltage and power so as to be adaptable to various electric network and power.

This embodiment employs a rectifier bridge constituted by four rectifier diodes to drive the AC LED drive circuit of LEDs so as to make the availability of LED up to 100%, thereby improving the light efficiency and reducing the cost. Additionally, the rectifier diode and the current constant diode are encapsulated within the LED by connecting a current constant diode to the rectifier bridge output, such that commercially available AC power can directly drive LEDs, and thus the defect of AC LED output current being changed with the input of voltage is eliminated, while broadening the range of voltage input and enhancing the applicability.

### Third Embodiment

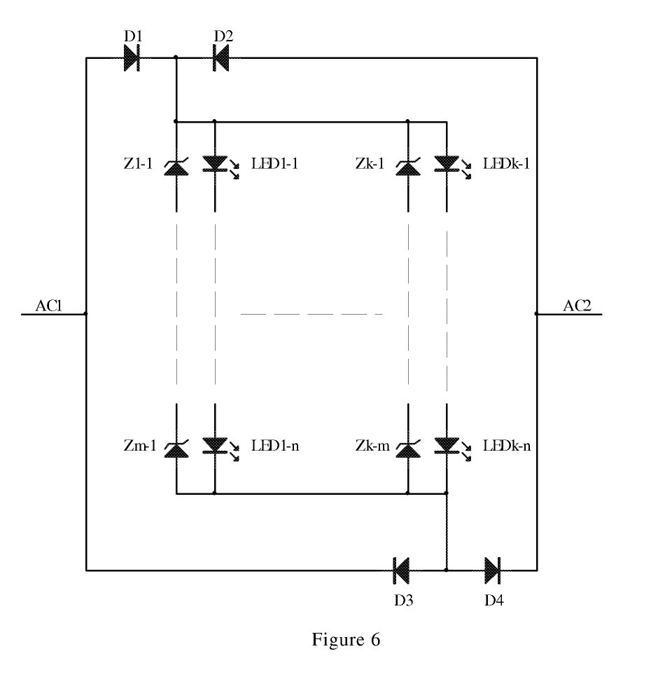

In the embodiment of the present patent application, a circuit principle drawing of the AC LED drive circuit will be shown in FIG. 6, and the circuit includes four rectifier diodes, and k groups of LED units in parallel connection, wherein k is a natural number.

The four rectifier diodes includes a first rectifier diode D1, a second rectifier diode D2, a third rectifier diode D3 and a fourth rectifier diode D4, and the four rectifier diodes constitute the full bridge rectifier, two input terminals of which are connected with two terminals AC1, AC2 of AC input, respectively.

The LED unit includes n LED(s) in serial connection, wherein n is a natural number. The k groups of LED units in parallel connection include the first group of LED unit(s), . . . , the kth group of LED(s), wherein the fist group of LED unit(s) includes LED 1_1, . . . , LED 1_N, . . . , and the kth group of LED(s) includes LED k_1, . . . , LED k_n.

In the k groups of LED units in parallel connection, each LED unit group is connected in parallel with a voltage stabilizing diode unit, as the first voltage stabilizing diode unit, . . . , the kth voltage stabilizing diode unit, respectively; the voltage stabilizing diode unit includes m voltage stabilizing diodes in series collection, wherein m is a natural number; the first voltage stabilizing unit includes Z 1_1, . . . Z 1_{—}m, . . . , and the Kth voltage stabilizing diode unit includes Z k_1, . . . , Z k_m.

The negative electrode of the first voltage stabilizing diode in voltage stabilizing diode units is connected with the respective positive electrode of the first LED in LED units, and the positive electrode of the mth voltage stabilizing diode is connected with the respective negative electrode of the nth LED. In this embodiment, the negative electrodes of Z 1_1, . . . , Z k_1 are connected with the positive electrodes of LED 1_1, . . . , LED k_1, respectively; the positive electrodes of Z 1_{—}m, . . . , Z k_m are connected with the negative electrodes of LED 1_{—}n, . . . , LED k_n, respectively.

In the present patent application, the voltage stabilizing diode units may include a voltage stabilizing diode unit, or alternatively includes a plurality of voltage stabilizing diodes; the connecting methods of the voltage stabilizing diode units and the corresponding LED units includes a voltage stabilizing diode being in parallel connection with a LED, a voltage stabilizing diode being in parallel connection with a plurality of serially connected LEDs, and a LED being in parallel connection with a plurality of serially connected voltage stabilizing diodes, and the combination thereof.

The present embodiment distinguishes from first embodiment in the following: when the AC LED drive circuit in this embodiment is employed, the electrical current flows through the voltage stabilizing diode circuit that is in parallel connection with the AC LED drive circuit even though the parts of LED circuit are in failure, without effecting the normal work of the LED circuit.

This embodiment employs a rectifier bridge constituted by four rectifier diodes to drive the AC LED drive circuit of the LEDs so as to make the availability of LED up to 100%, thus improving the light efficiency and reducing the cost. Further, in this embodiment, each of LED units is in parallel connection with voltage stabilizing diode unit, and thereby even though the parts of LED circuit are in failure, remaining LEDs may normally work without any influence.

### Fourth Embodiment

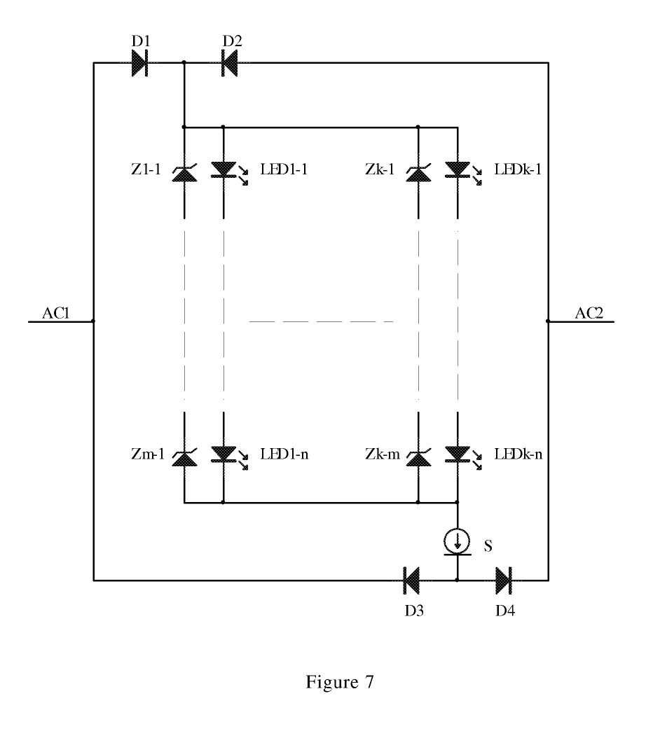

In the embodiment of the present patent application, a circuit principle drawing of the AC LED drive circuit will be shown in FIG. 7, and the circuit includes four rectifier diodes, a current constant diode S and k groups of LED units in parallel connection, wherein k is a natural number.

The four rectifier diodes includes a first rectifier diode D1, a second rectifier diode D2, a third rectifier diode D3 and a fourth rectifier diode D4, and the four rectifier diodes constitute the full bridge rectifier, two input terminals of which are connected with two terminals AC1, AC2 of AC input, respectively. The positive input terminals are connected with positive common terminals of k groups of LED units in parallel connection, and the negative input terminals are connected with the negative electrodes of current constant diode.

The current constant diode S is serially connected with the k groups of LED units in parallel connection, wherein the positive electrode thereof is connected with the negative common terminal of the k groups of LED units in parallel connection.

The LED unit includes n LED(s) in serial connection, wherein n is a natural number. The k groups of LED units in parallel connection include the first group of LED unit(s), . . . , the kth group of LED(s), wherein the fist group of LED unit(s) includes LED 1_1, . . . , LED 1_N, . . . , and the kth group of LED(s) includes LED k_1, . . . , LED k_n.

In the k groups of LED units in parallel connection, each LED unit group is connected in parallel with a voltage stabilizing diode unit, as the first voltage stabilizing diode unit, . . . , the kth voltage stabilizing diode unit, respectively; the voltage stabilizing diode unit includes m voltage stabilizing diodes in series collection, wherein m is a natural number; the first voltage stabilizing unit includes Z 1_1, . . . Z 1_{—}m, . . . , and the Kth voltage stabilizing diode unit includes Z k_1, . . . , Z k_m.

The negative electrode of the first voltage stabilizing diode in voltage stabilizing diode units is connected with the respective positive electrode of the first LED in LED units, and the positive electrode of the mth voltage stabilizing diode is connected with the respective negative electrode of the nth LED. In this embodiment, the negative electrodes of Z 1_1, . . . , Z k_1 are connected with the positive electrodes of LED 1_1, . . . , LED k_1, respectively; the positive electrodes of Z 1_{—}m, . . . , Z k_m are connected with the negative electrodes of LED 1_{—}n, . . . , LED k_n, respectively.

In the present patent application, the voltage stabilizing diode units may include a voltage stabilizing diode unit, or alternatively includes a plurality of voltage stabilizing diodes; the connecting methods of the voltage stabilizing diode units and the corresponding LED units includes a voltage stabilizing diode being in parallel connection with a LED, a voltage stabilizing diode being in parallel connection with a plurality of serially connected LEDs, and a LED being in parallel connection with a plurality of serially connected voltage stabilizing diodes, and the combination thereof.

In this embodiment, AC LED include a plurality of low-voltage LED wafer connected by golden wire or is formed by in a grain of LED in which a high-voltage LED wafer, a rectifier diode wafer and a current constant diode wafer are encapsulated, or alternatively AC LED is formed by separate elements without encapsulation. When the AC LED drive circuit in this embodiment is employed, it is optional to encapsulate various grains of LED according to various power supply voltage and power so as to be adaptable to various electric network and power.

This embodiment distinguishes from second embodiment in the following: when the AC LED drive circuit in this embodiment is employed, the electrical current flows through the voltage stabilizing diode circuit that is in parallel connection with the AC LED drive circuit even though the parts of LED circuit are in failure, without effecting the normal work of the LED circuit.

This embodiment employs a rectifier bridge constituted by four rectifier diodes to drive the AC LED drive circuit of the LEDs so as to make the availability of LED up to 100%, thus improving the light efficiency and reducing the cost. Additionally, the rectifier diode and the current constant diode are encapsulated within the LED by connecting a current constant diode to the rectifier bridge output, such that commercially available AC power can directly drive LEDs, and thus the defect of AC LED output current being changed with the input of voltage is eliminated, while broadening the range of voltage input and enhancing the applicability. Furthermore, in this embodiment, each of LED units is in parallel connection with voltage stabilizing diode unit, and thereby even though the parts of LED circuit are in failure, remaining LEDs may normally work without any influence.

The above are merely advantageous embodiments of the present patent application. A ordinary skilled in the art should note that various improvements and modifications can be made to the present patent application without going beyond the scope of technical principle of the present patent application, and those improvements and modifications should also be regarded as protection scope of the present patent application.

1. An AC LED drive circuit, wherein the circuit comprises four rectifier diodes and k groups of LED units in parallel connection, wherein k is a natural number; a full bridge rectifier circuit comprises four rectifier diodes which has two input terminals being connected with two terminals AC1, AC2 of the AC input respectively, the positive electrode output terminal being connected with the positive common terminal of the k groups of LED units in parallel connection; the negative electrode output terminal being connected with the negative common terminal of the k groups of LED units in parallel connection; the LED unit comprises n LEDs in serial connection, wherein n is a natural number.

2. The AC LED drive circuit according in claim 1, wherein the circuit further comprises a current constant diode which is serially connected with k groups of LED units in parallel connection.

3. The AC LED drive circuit according in claim 1, wherein in k groups of LED units in parallel connection, each LED unit is in parallel connection with a voltage stabilizing diode unit that comprise m voltage stabilizing diodes in serial connection, wherein m is a natural number; the negative electrode of the first voltage stabilizing diode in the voltage stabilizing diode unit is connected with the positive electrode of the first LED in the LED units, and the positive electrode of mₜₕ voltage stabilizing diode is connected with the negative electrode of the nₜₕ LED.

4. The AC LED drive circuit according in claim 3, wherein the positive electrode of voltage stabilizing diode in the voltage stabilizing diode unit is connected with the respective negative electrode of LED corresponding in the LED unit, and the negative electrode of voltage stabilizing diode is connected with the respective positive electrode of LED.

5. The AC LED drive circuit according in claim 2, wherein in k groups of LED units in parallel connection, each LED unit is in parallel connection with a voltage stabilizing diode unit that comprise m voltage stabilizing diodes in serial connection, wherein m is a natural number; the negative electrode of the first voltage stabilizing diode in the voltage stabilizing diode unit is connected with the positive electrode of the first LED in the LED units, and the positive electrode of mₜₕ voltage stabilizing diode is connected with the negative electrode of the nₜₕ LED.
